(19) United States
(12) Patent Application Publication
(10) Pub. No.: US 2009/0033011 A1
(43) Pub. Date: Feb. 5, 2009

(54) Cushion

(76) Inventor: Tsung Jen CHEN, Chiayi City (TW)

Correspondence Address: Dr. BANGER SHIA;Int''l Patent Office of Bang Shia, 102 Lindencrest Ct, Sugar Land, TX, 77479-5201, US

(21) Appl. No.: 12/182,866

(22) Filed: Jul. 30, 2008

(30) Foreign Application Priority Data
Aug. 3, 2007 (TW) 096128600

(51) Int. Cl. F16F 1/04

(52) U.S. Cl. 267/286

(57) ABSTRACT

A cushion includes a cylinder, a base, an elastic element, a first bushing and a second bushing. The cylinder is made of a composite material and formed with a lug. The base is made of a composite material and formed with a lug at an end and a threaded bolt at another end. The threaded bolt is inserted into the cylinder. The elastic element is compressed between the cylinder and the base. The first bushing is disposed in the lug of the cylinder. The first bushing is made of another material than the composite material of the cylinder. The second bushing is disposed in the lug of the base. The second bushing is made of another material than the composite material of the base.

### BACKGROUND OF INVENTION

1. Field of Invention

The present invention relates to a cushion and, more particularly, to a light, strong, inexpensive cushion.

2. Related Prior Art

A mountain bike is generally equipped with two front cushions and a rear cushion. The front cushions are provided on a front fork. The rear cushion is provided between a rear fork and a frame of the mountain bike. As propelled by a rider, the mountain bike would better be light. Hence, the cushions would better be light.

Referring to FIG. 1, a conventional cushion includes a cylinder 10, a base 20 and a helical spring 30. The cylinder 10 and the base 20 are generally made of aluminum. The helical spring 30 is generally made of steel. The cylinder 10 is formed with a thread 11 on an external side and a lug 12 at an end. A bushing 13 is disposed in the lug 12. There is provided a ring 15. The ring 15 is formed with a thread on an internal side. The thread of the ring 15 is engaged with the thread 11 of the cylinder 10. The base 20 includes a lug 22 formed at an end. A bushing 23 is disposed in the lug 22. A rod 25 is formed with a head at an end and a thread near another end. The head of the rod 25 is retained in the cylinder 10. The rod 25 is inserted through an annular piston 26. The piston 26 is movable in the cylinder 10. The thread of the rod 25 is engaged with a thread formed on an internal side of the base 20. The helical spring 30 is compressed between the ring 15 and the base 20 to cushion. A pin can be inserted through the bushing 13 and driven into a frame of a bicycle. Another pin can be inserted through the bushing 23 and driven into a rear fork. Thus, the cushion is provided between the frame and the rear fork. By rotating and therefore moving the ring 15 along the cylinder 10, the stress in the helical spring 30 is adjusted.

However, the cushion is heavy since the cylinder 10 and the base 20 are made of aluminum. Moreover, it is expensive since the cylinder 10 and the base 20 are cast, and the casting is expensive. Furthermore, it is getting expensive since the costs of metals are skyrocketing.

The present invention is therefore intended to obviate or at least alleviate the problems encountered in prior art.

### SUMMARY OF INVENTION

It is the primary objective of the present invention to provide a light, strong, inexpensive cushion.

To achieve the primary objective of the present invention, the cushion includes a cylinder, a base, an elastic element, a first bushing and a second bushing. The cylinder is made of a composite material and formed with a lug. The base is made of a composite material and formed with a lug at an end and a threaded bolt at another end. The threaded bolt is inserted into the cylinder. The elastic element is compressed between the cylinder and the base. The first bushing is disposed in the lug of the cylinder. The first bushing is made of another material than the composite material of the cylinder. The second bushing is disposed in the lug of the base. The second bushing is made of another material than the composite material of the base.

Other objectives, advantages and features of the present invention will become apparent from the following description referring to the attached drawings.

### BRIEF DESCRIPTION OF DRAWINGS

The present invention will be described via the detailed illustration of the preferred embodiment versus a conventional cushion referring to the drawings.

FIG. 1 is an exploded view of a conventional cushion.

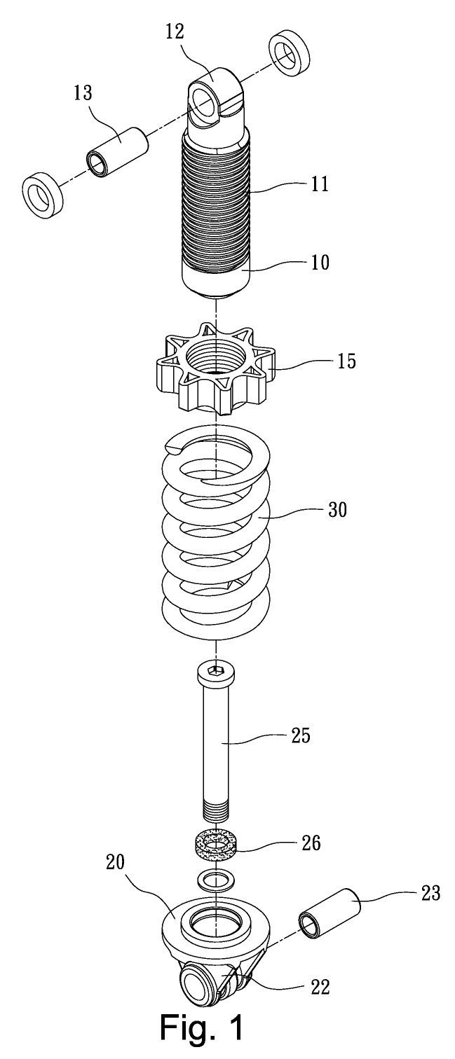

FIG. 2 is an exploded view of a cushion according to the preferred embodiment of the present invention.

FIG. 3 is a perspective view of the cushion shown in FIG. 2.

FIG. 4 is a cross-sectional view of the cushion shown in FIG. 2.

FIG. 5 is a cross-sectional view of the cushion in a less stressed idle position than shown in FIG. 4.

FIG. 6 is a cross-sectional view of the cushion moved to an active position from the idle position shown in FIG. 4.

### DETAILED DESCRIPTION OF PREFERRED EMBODIMENT

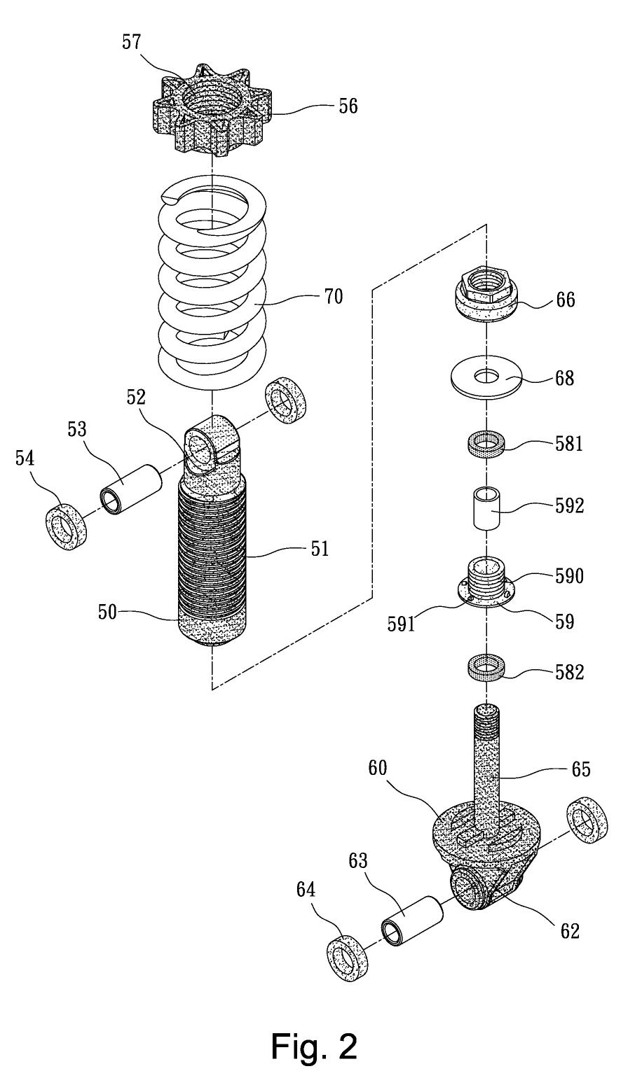

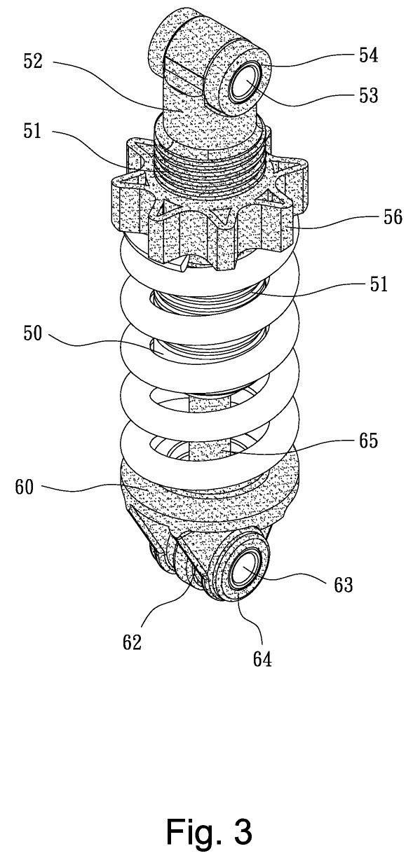

Referring to FIGS. 2 through 4, a cushion includes a cylinder 50, a base 60 and an elastic element 70. The cylinder 50 is made of a composite material. The base 60 is made of a composite material. The material of the cylinder 50 and the material of the base 60 may or may not be identical to each other.

The cylinder 50 is formed with a thread 51 on an external side, a lug 52 at a first end, a thread 500 on an internal side near a second end and recesses 501 at the second end. A bushing 53 is disposed in the lug 52. The bushing 53 may be embedded in the lug 52 during the injection molding of the cylinder 50. The bushing 53 is preferably made of a metal to enhance the lug 52, which is made of a composite material. Two bearings 54 are mounted on the bushing 53 so that the lug 52 is located between the bearings 54.

There is provided a ring 56. The ring 56 is formed with a thread 57 on an internal side. The thread 57 of the ring 56 is engaged with the thread 51 of the cylinder 50.

The base 60 is formed with a lug 62 at an end and a threaded bolt 65 at another end. A bushing 63 is disposed in the lug 62. The bushing 63 may be embedded in the lug 62 during the injection molding of the base 60. The bushing 63 is preferably made of a metal to enhance the lug 62, which is made of a composite material. The threaded bolt 65 is inserted in the cylinder 50.

A buffering ring 582 is provided on the threaded bolt 65. An annular restraint 59 is provided on the threaded bolt 65. The annular restraint 59 is made of plastics or a composite material. In any case, the material of the annular restraint 59 is different from that of the threaded bolt 65 so that they would not be fused. The annular restraint 59 is formed with a thread 590 on an external side and bosses 591 thereon. A bushing 592 is fit in the annular restraint 59 and mounted on the threaded bolt 65. The bushing 592 is made of a metal. A buffering ring 581 is provided on the threaded bolt 65. An annular slide 68 is provided on the threaded bolt 65. The annular slide 68 is made of a metal unlike the cylinder 50 made of a composite material. Hence, the annular slide 68 and the cylinder 50 would not be fused while the annular slide 68 slides in the cylinder 50. A nut 66 is engaged with the threaded bolt 65.

The thread 590 of the annular restraint 59 is engaged with the thread 500 of the cylinder 50. When the thread 590 is firmly engaged with the thread 500, the bosses 591 of the annular restraint 59 are disposed into the recesses 501 of the cylinder 50. The bosses 591 and the recesses 501 are made so that the former cannot be removed from the latter. Thus, the threaded bolt 65 is always connected to the cylinder 50.

The elastic element 70 is preferably a helical spring made of steel. In another embodiment, the elastic element 70 may be a sleeve made of an elastomer. The elastic element 70 is compressed between the ring 56 and the base 60 to cushion.

A pin can be inserted through the bushing 53 and the bearings 54 and driven into a frame of a bicycle for example. Another pin can be inserted through the bushing 63 and the bearings 64 and driven into a rear fork. Thus, the cushion is provided between the frame and the rear fork.

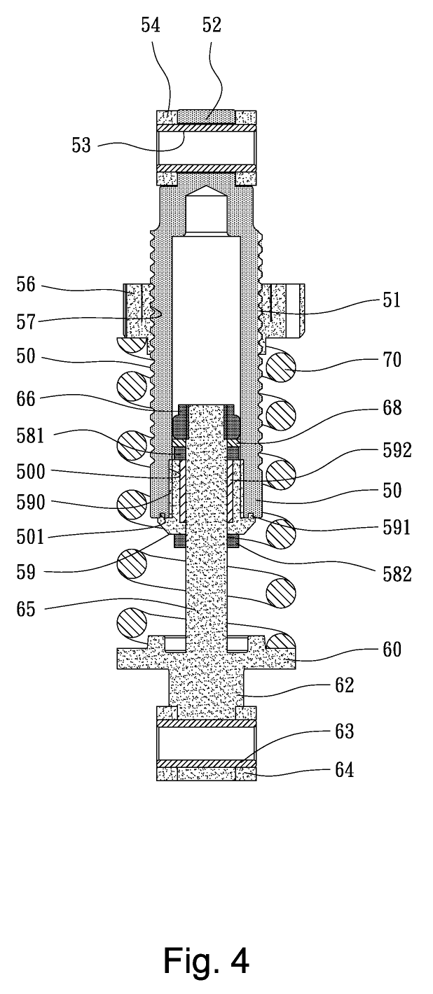

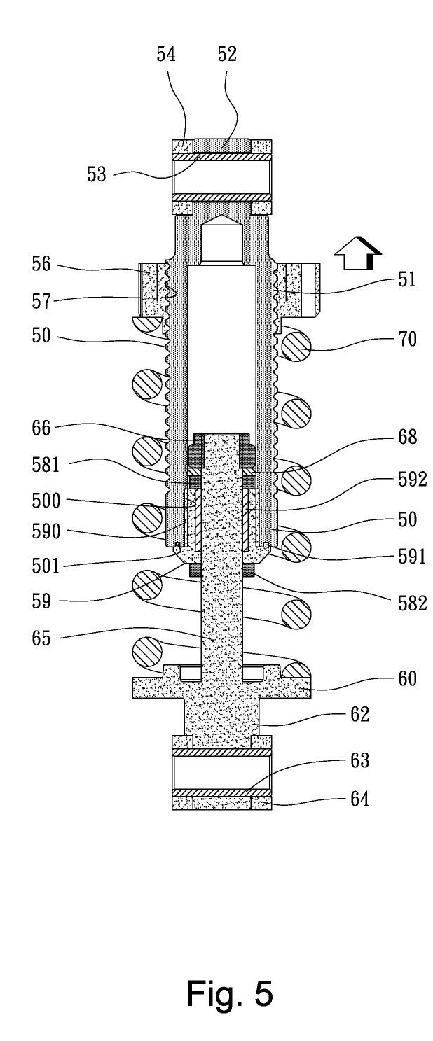

Referring to FIGS. 4 and 5, by rotating the ring 56 on the cylinder 50, the ring 56 is moved along the cylinder 50 to adjust the stress in the elastic element 70. The stress in the elastic element 70 shown in FIG. 4 is larger than the stress in the elastic element 70 shown in FIG. 5.

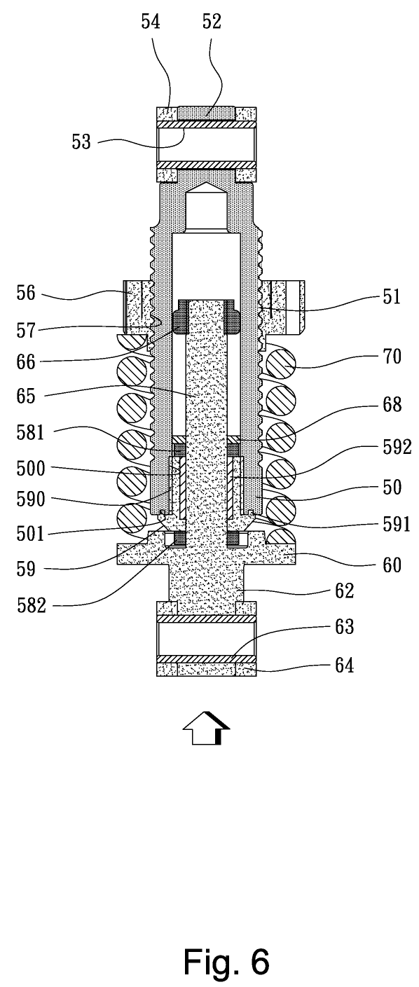

Referring to FIG. 6, the cushion is in an active position where the elastic element 70 is further compressed to cushion. When the elastic element 70 is further compressed, the threaded bolt 65 is further inserted into the cylinder 10 and the annular slide 68 is moved further into the cylinder 50.

The cushion according to the present invention exhibits several advantages. Firstly, it is light and strong because the cylinder 50, the ring 56 and the base 60 are made of a same composite material or different composite materials while the bushings 53 and 63 are made of a same metal or different metals.

Secondly, its cost in material is low because only a small amount of metal is used.

Thirdly, its cost in assembly is low since the base 60 and the threaded bolt 65 are made in one piece.

Fourthly, it is reliable partly because the cylinder 50 and the annular slide 68 are made of different materials and would not be fused with each other and partly because the annular restraint 59 and the threaded bolt 65 are made of different materials and would not be fused with each other.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cushion comprising:
a cylinder made of a composite material and formed with a lug;
a first bushing disposed in the lug of the cylinder and made of another material than the composite material of the cylinder;
a base made of a composite material and formed with a lug at an end and a threaded bolt at another end, wherein the threaded bolt is inserted into the cylinder;
a second bushing disposed in the lug of the base and made of another material than the composite material of the base; and
an elastic element compressed between the cylinder and the base.

2. The cushion according to claim 1, comprising a ring movably provided on the cylinder, wherein the elastic element is compressed between the ring and the base.

3. The cushion according to claim 2, wherein the ring comprises a thread on an internal side, and the cylinder comprises a thread engaged with the thread of the ring so that the ring is moved along the cylinder when the former is rotated on the latter.

4. The cushion according to claim 1, comprising two bearings mounted on the first bushing so that the lug of the cylinder is located between the bearings.

5. The cushion according to claim 1, comprising two bearings mounted on the second bushing so that the lug of the base is located between the bearings.

6. The cushion according to claim 1, wherein the first bushing is embedded in the lug of the cylinder during the injection molding of the cylinder.

7. The cushion according to claim 1, wherein the second bushing is embedded in the lug of the base during the injection molding of the base.

8. The cushion according to claim 1 comprising an annular restraint connected to the cylinder, wherein the threaded bolt is inserted through the annular restraint so that the annular restraint restrains at least a portion of the threaded bolt in the cylinder.

9. The cushion according to claim 8 comprising a nut engaged with the threaded bolt for abutment against the annular restraint.

10. The cushion according to claim 8, wherein the annular restraint comprises a thread on an external side, and the cylinder comprises a thread engaged with the thread of the annular restraint.

11. The cushion according to claim 10, wherein the annular restraint comprises bosses thereon, and the cylinder comprises recesses for receiving the bosses to stop the rotation of the annular restraint with respect to the cylinder.

12. The cushion according to claim 8 comprising two annular buffers at two opposite ends of the annular restraints.

13. The cushion according to claim 8 comprising a metal bushing fit in the annular restraint and mounted on the threaded bolt.

14. The cushion according to claim 1, wherein the elastic element is a helical spring.
